(19) United States
(12) Patent Application Publication
(10) Pub. No.: US 2008/0288175 A1
(43) Pub. Date: Nov. 20, 2008

(54) INFORMATION PROCESSING APPARATUS, INFORMATION PROCESSING METHOD, AND PROGRAM

(76) Inventors: Shinako MATSUYAMA, Tokyo (JP); Yu Hamada, Tokyo (JP); Tetsuya Shiraishi, Tokyo (JP); Junji Suzuki, Tokyo (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/949,531

(22) Filed: Dec. 3, 2007

(30) Foreign Application Priority Data
Dec. 20, 2006 (JP) P2006-342873

(51) Int. Cl. G06F 19/00

(52) U.S. Cl. 702/19

(57) ABSTRACT

An information processing apparatus is disclosed which processes information about a network including a plurality of nodes representative of cellular molecules, the information processing apparatus including a detection section configured to detect from the network a node group corresponding to a switch pattern including at least two nodes potentially constituting a candidate of a molecular switch.

### CROSS REFERENCES TO RELATED APPLICATIONS

The present invention contains subject matter related to Japanese Patent Application ,JP 2006-342873 filed with the Japan Patent Office on Dec. 20, 2006, the entire contents of which being incorporated herein by reference.

### BACKGROUND OF THE INVENTION

1. Field of the Invention

The present invention relates to an information processing apparatus, an information processing method, and a program. More particularly, the invention relates to an information processing apparatus, an information processing method, and a program for implementing techniques with which to detect molecular switches from cellular networks and to study the state of the detected switches.

2. Description of the Related Art

A cell may be regarded as a network of a plurality of molecules linked as nodes. This network will be referred to as a cellular network in the description that follows.

In the cellular network, groups of molecules involved in transmitting information adjust groups of cellular functions by performing switching actions (on/off actions) on the groups. These adjustments help maintain the homeostasis of the network through quick responses to changes in the internal and external environments.

There exist molecules which remain off (inactive and nonfunctional) under normal conditions but which are turned on (active and functional) under specific conditions. These molecules will be referred to as molecular switches in the ensuing description.

illustratively, “Modeling Genetic Switches with Positive Feedback Loops” (by Tetsuya Kobayashi, Luonan Chen and Kazuyuki Aihara; Journal of Theoretical Biology (2003) 221, pp. 378-399) discusses conditions for constituting a switching action through direct/indirect interactions between two molecules (two nodes), hereinafter referred to as a Non-patent Document. According to the document, the conditions involve having a positive loop formed by the node group with its two nodes linked directly or indirectly.

FIG. 1 shows a typical positive loop. In FIG. 1, circles each with a number inside are nodes representative of molecules.

A positive (+) arrow indicates that a first node at the originating extremity of the arrow is linked to a second node at the tip of the arrow in such a manner that the first node renders the function of the second node positive (promoted/strengthsneol/increased). This link will be referred to as a P link in the ensuing description.

A negative (−) arrow indicates that the first node at the originating extremity of the arrow is linked to the second node at the tip of the arrow in such a manner that the first node renders the function of the second node negative (suppressed/weakened/decreased), This link will be referred to as an N link in the ensuing description.

As can be seen from the link state of node 5 in FIG. 5, there is a case where the second node doubles as the first node. In this case, the first nods is linked to itself (as the second node) in a P link or in an N link.

A loop is formed by at least two nodes. Each of the paths linking the nodes in the loop is marked with a positive (+) sign for a P link or with a negative (−) sign for an N link. If multiplying the signs of ail paths results in a plus, then the loop is the to be a positive loop.

In FIG. 1, for example, a loop formed by node 6 being followed by nodes 1, 2, 3 and 6, in that order, involves two positive (+) signs and two negative (−) signs. This loop thus turns out to be a positive loop. The group of nodes (molecules) constituting such a positive loop may become a molecular switch candidate.

In cancer ceils, abnormalities in information transmission paths are known to trigger unlimited cancer growth. In that respect, examining the state of molecular switches is expected to contribute significantly to estimating the process of carcinogenesis and discovering cures for cancer.

### SUMMARY OF THE INVENTION

The Non-patent Document merely suggests molecular switch candidates theoretically. Techniques have yet to be established to actually detect molecular switches from cellular net/works such as cancer cells and to examine the state of these actually detected molecular switches.

The present invention has been made in view of the above circumstances and provides arrangements for implementing the techniques with which to detect molecular switches from cellular networks and examine the state of these switches.

In carrying our an embodiment of the present invention, there is provided an information processing apparatus for processing information about a network including a plurality of nodes representative of cellular molecules, the information processing apparatus including a detection section configured to detect from the network a node group corresponding to a switch pattern including at least two nodes potentially constituting a candidate of a molecular switch.

Preferably, the switch pattern may be defined as a positive group in which at most two paths link the two nodes potentially constituting the candidate of the molecular switch; and the detection section may detect the node group corresponding to the switch pattern based on the definition of the pattern.

Preferably, the switch pattern may be defined as one of a plurality of positive loop types; and the detection section may detect a node group corresponding to one of the plurality of positive loop types as the node group corresponding to the switch pattern.

Preferably, if a first node links to a second node in such a manner that the first node renders the second node functionally positive, then the link may be defined as a P link. If first node links to the second nodes in such a manner that the first node renders the second node functionally negative, then the link may be defined as an N link. If the first node links to the second node in the P link or in the N link and if the second node links to the first node also in the P link or in the N link, then the link may be defined as a PP link or an NN link, respectively. The PP link and the NN link are defined as a same-sign link each. Of the node group constituting the positive loop, the two nodes potentially constituting the candidate of the molecular switch may be regarded as target nodes and the other nodes as related nodes. The plurality of positive loop types may include a first, a second, and a third type. The first type involves the two target nodes being linked to each other in the NN link and each of the two target nodes linking to itself in the P link. The second type involves the two target nodes being linked to each other in the NN link and each of the two target nodes being linked with the related nodes in the same-sign link. The third type involves the two target nodes being linked bidirectionally via one of the related nodes and each of the two target nodes being linked with the other related nodes in the same-sign link.

Preferably, following the detection of at least the node group corresponding to the switch pattern including at least the two nodes potentially constituting the candidate of the molecular switch, if one of the two nodes is found increasing in terms of either expression level or expression degree upon transition from a normal condition to a specific condition and if the other node is found decreasing in terms of either expression level or expression degree upon transition from the normal condition to the specific condition, then the detection section may regard the node group as a node group including the molecular switch.

Preferably, under each of the normal condition and the specific condition, there may be provided verification data indicating at least either the expression level or the expression degree regarding the molecules potentially constituting the nodes of the network; and based on the verification data, the detection section may detect the node group including the molecular switch from at least the node group corresponding to the switch pattern.

There is also provided an information processing method as well as a program functionally corresponding to the above-outlined information processing apparatus according to the present invention.

That is, according to another embodiment of the present invention, there is provided an information processing method for use with an information processing apparatus for processing information about a network including a plurality of nodes representative of cellular molecules, as well as a program for causing a computer to perform: the same processing as the apparatus, the information processing method and the program each including the step of defecting from the network a node group corresponding to a switch pattern including at least two nodes potentially constituting a candidate of a molecular switch.

As necessary, following the detection of at least the node group corresponding to the switch pattern including at least the two nodes potentially constituting the candidate of the molecular switch, if one of the two nodes is found increasing in terms of either expression level or expression degree upon transition from a normal condition to a specific condition and if the other node is found decreasing in terms of either expression level or expression degree upon transition from the normal condition to the specific condition, then the node group may be regarded as a node group including the molecular switch.

According to the embodiment of the present invention, cellular networks are analyzed as outlined above. In particular, the embodiment of the invention provides techniques for detecting a molecular switch from a given cellular network and examining the state of the detected molecular switch.

### BRIEF DESCRIPTION OF THE DRAWINGS

FIG. 1 is a schematic view explanatory of a typical positive loop;

FIG. 2 is a functional block diagram showing a typical functional structure of an information processing apparatus practiced as an embodiment of the present invention;

FIG. 3 is a schematic view showing a typical switch pattern detected by the information processing apparatus in FIG. 2;

FIG. 4 is a schematic view showing another typical switch pattern detected by the information processing apparatus in FIG. 2;

FIG. 5 is a schematic view showing still another typical switch pattern detected by the information processing apparatus in FIG. 2;

FIG. 6 is a schematic view showing an example of the switch pattern in FIG. 5;

FIG. 7 is a schematic view showing a different example of the switch pattern in FIG. 5;

FIG. 8 is a flowchart of steps constituting a typical switch pattern detecting process performed by the information processing apparatus in FIG. 2;

FIG. 9 is a tabular view showing typical results of the switch pattern detecting process in FIG. 8;

FIG. 10 is a flowchart of steps constituting a typical switch pattern verifying process performed by the information processing apparatus in FIG. 2;

FIG. 11 is a tabular view showing typical results of the switch pattern verifying process in FIG. 10;

FIG. 12 is a schematic view showing a typical structure of principal data for use by the information processing apparatus in FIG. 2; and

FIG. 13 is a block diagram showing a typical structure of a computer that runs software for carrying out information processing according to an embodiment of the present invention.

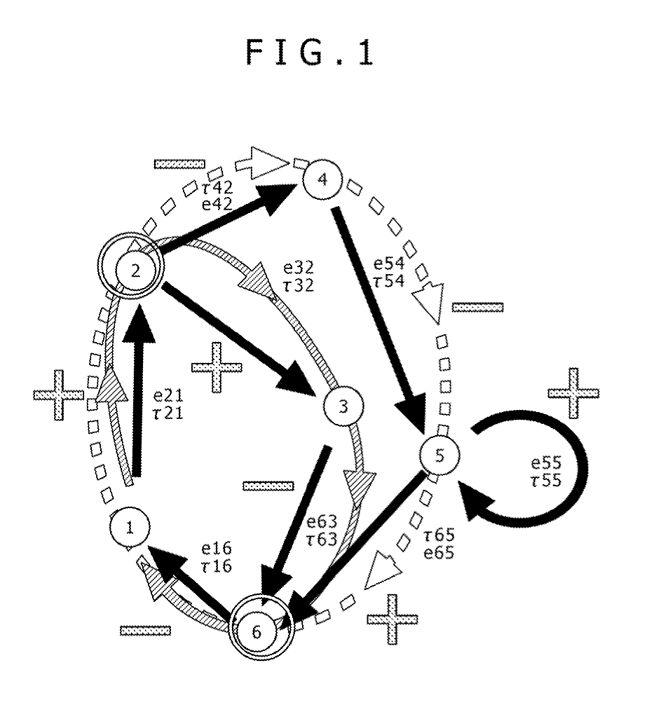

### DETAILED DESCRIPTION OF THE PREFERRED EMBODIMENTS

What, is described below as the preferred embodiments of the present invention with reference to the accompanying drawings corresponds to the appended claims as follows; the description of the preferred embodiments basically provides specific examples supporting what is claimed. If any example of the invention described below as a preferred embodiment does not have an exactly corresponding claim, this does not means that the example in question has no relevance to the claims. Conversely, if any example of the invention described hereunder has a specifically corresponding claim, this does not mean that the example in question is limited to that claim or has no relevance to other claims.

Furthermore, the description below of the preferred embodiments with reference to the accompanying drawings does not claim to include all examples corresponding to the whole claims. In other words, the description hereunder does not limit or deny any inventive entities which are not covered by the appended claims of the present invention but which may be added or brought about by this applicant in the future by divisional application or by amendment.

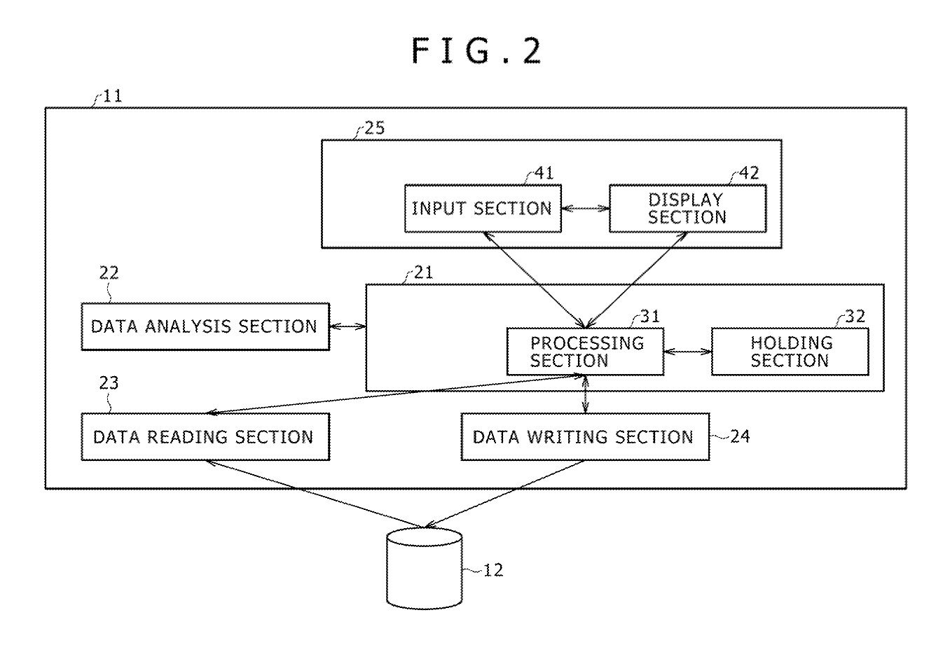

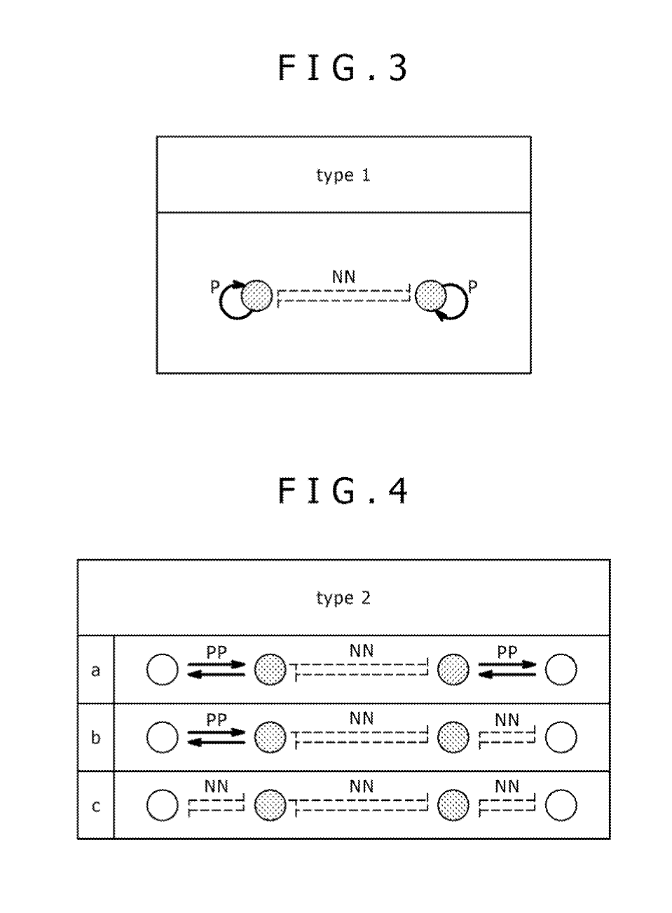

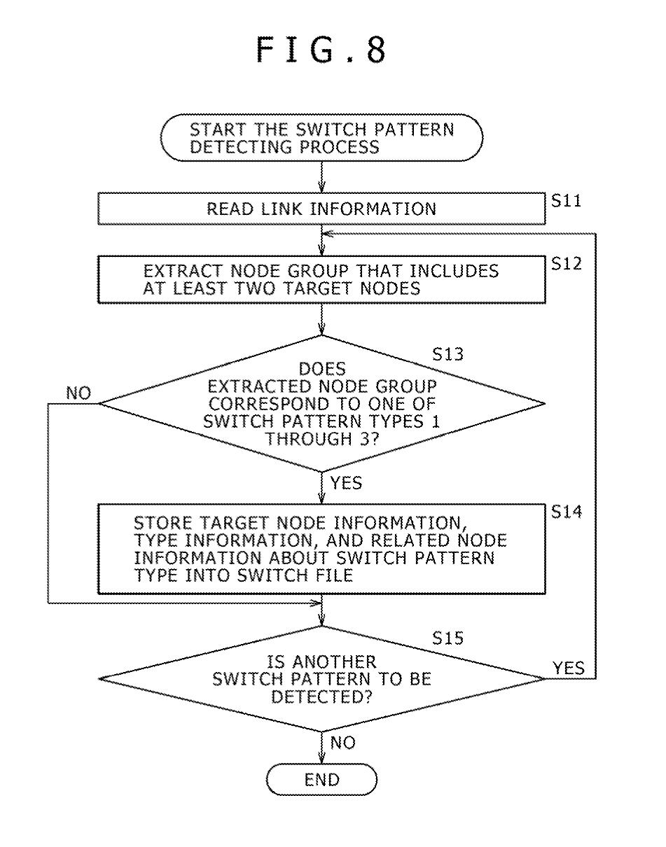

An embodiment of the present invention is an information processing apparatus (e.g., information processing apparatus 11 in FIG. 2) for processing information about a network including a plurality of nodes representative of cellular molecules, the information processing apparatus includes a detection section. The detection section (e.g., processing section 31 in FIG. 2 and/or data analysis section 22 under control of the processing section 31) is configured to detect (e.g., by performing the switch pattern detecting process in FIG. 8) from the network a node group corresponding to a switch pattern (e.g., one of the switch patterns in FIGS. 3 through 7) including at least two nodes potentially constituting a candidate of a molecular switch.

Preferably, the switch pattern may be defined as a positive group (e.g., as each of the switch patterns in FIGS. 3 through 7) in which at most two paths link the two nodes potentially constituting the candidate of the molecular switch; and the detection section may detect the node group corresponding to the switch pattern based on the definition of the pattern.

Preferably, the switch pattern may be defined as one of a plurality of positive loop types (e.g., type 1 through type 3 in FIGS. 3 through 7); and the detection section may detect (e.g., in steps S13 and S14 of FIG. 8) a node group corresponding to one of the plurality of positive loop types as the node group corresponding to the switch pattern.

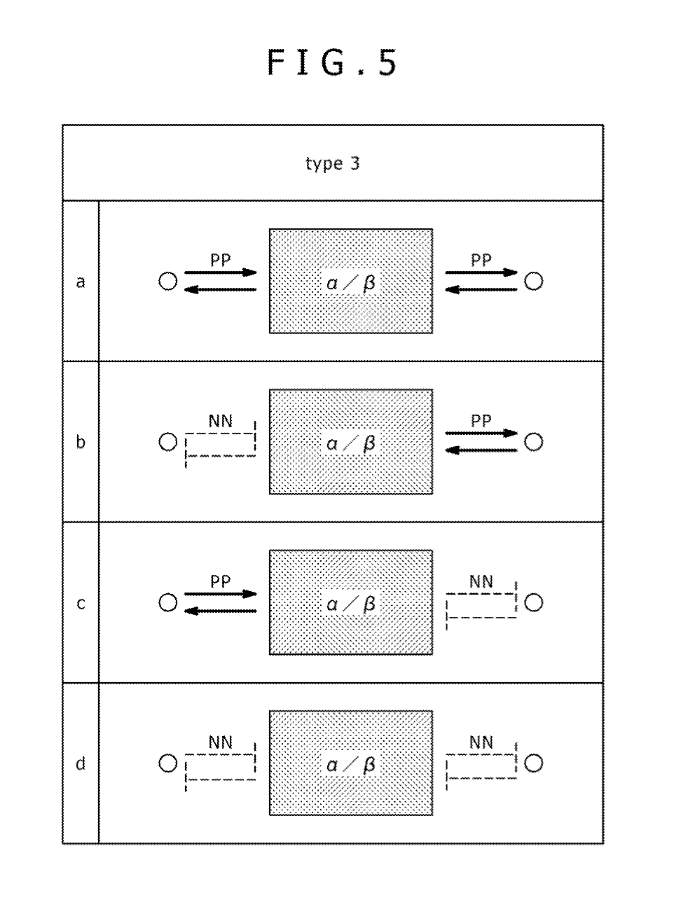

Preferably, if a first node links to a second node in such a manner that the first node renders the second node functionally positive, then the link may be defined as a P link. If first node links to the second nodes in such a manner that the first, node renders the second node functionally negative, then the link may be defined as an N link. If the first node links to the second node in the P link or in the N link and if the second node links to the first node also in the P link or in the N link, then the link may be defined as a PP link or an NN link, respectively. The PP link and the NN link are defined as a same-sign link each. Of the node group constituting the positive loop, the two nodes potentially constituting the candidate of the molecular switch may be regarded as target nodes and the other nodes as related nodes. The plurality of positive loop types may include a first, a second, and a third type. The first type (e.g., type 1 in FIG. 3) involves the two target nodes being linked to each other in the NN link and each of the two target nodes linking to itself in the P link. The second type (e.g., type 2 in FIG. 4) involves the two target nodes being linked to each other in the NN link and each, of the two target nodes being linked with the related nodes in the same-sign link. The third type (e.g., type 3 in FIGS. 5 through 7) involves the two target nodes being linked bidirectionally via one of the related nodes and each of the two target nodes being linked with the other related nodes in the same-sign link.

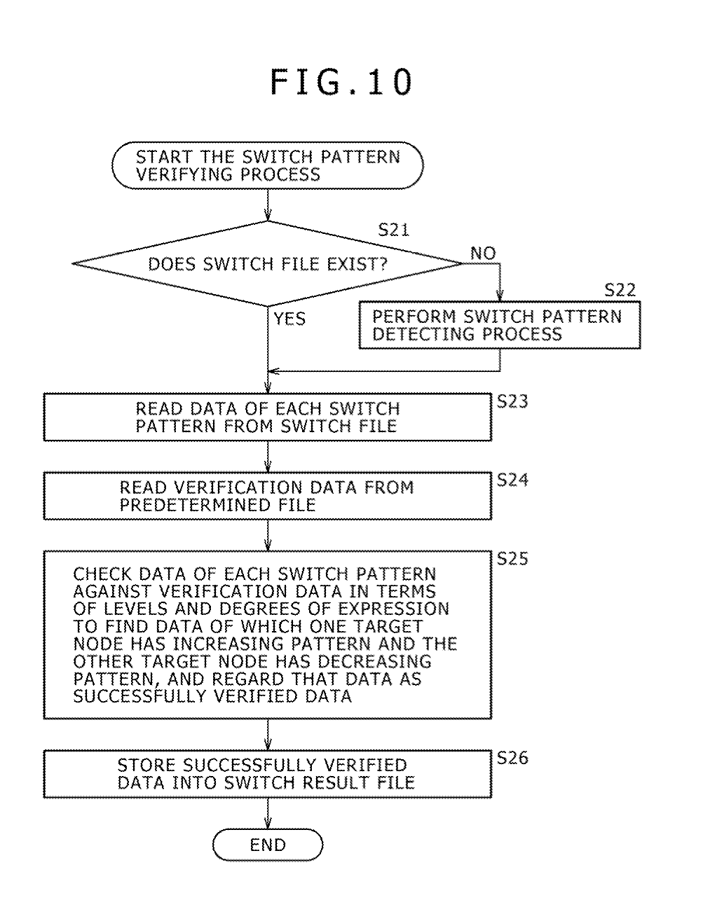

Preferably, following the detection of at least the node group corresponding to the switch pattern including at least the two nodes potentially constituting the candidate of the molecular switch, if one of the two nodes is found increasing in terms of either expression level or expression degree upon transition from a normal condition to a specific condition and if the other node is found decreasing in terms of either expression level or expression degree upon transition from the normal condition to the specific condition, then the detection section may regard the node group as a node group including the molecular switch (e.g., by carrying out the switch pattern verifying process in FIG. 10).

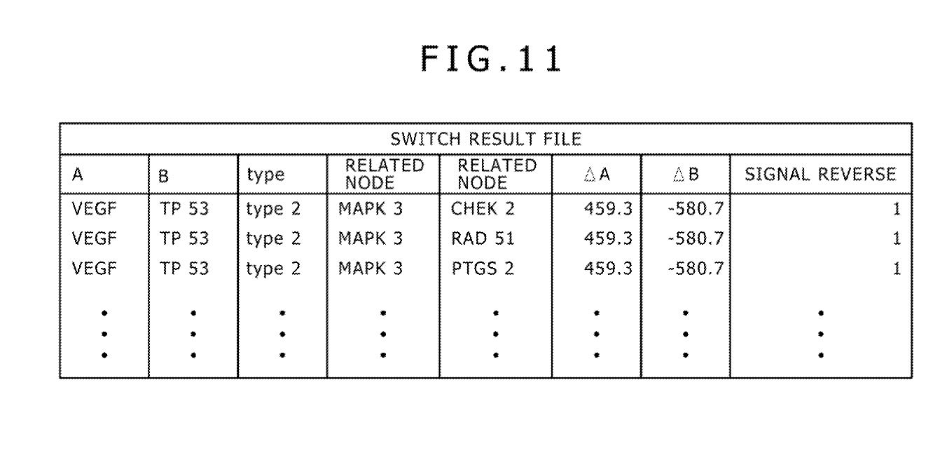

Preferably, under each of the normal condition and the specific condition, there may be provided verification data (e.g., verification data in step S24 of FIG. 10, from which “ΔA” and “ΔB” in FIG. 11 are generated) indicating at least either the expression level or the expression degree regarding the molecules potentially constituting the nodes of the network. Based on the verification data, the detection section may detect the node group including the molecular switch from at least the node group corresponding to the switch pattern.

Another embodiment of the present, invention is an information processing method for use with an information processing apparatus (e.g., information processing apparatus 11 in FIG. 2) for processing information about a network including a plurality of nodes representative of cellular molecules. The information processing method includes the step of detecting (e.g., by performing the switch pattern verifying process in FIG. 8) from the network a node group corresponding to a switch pattern including at least two nodes potentially constituting a candidate of a molecular switch.

Preferably, following the detection of at least the node group corresponding to the switch pattern including at least the two nodes potentially constituting the candidate of the molecular switch, if one of the two nodes is found increasing in terms of either expression level or expression degree upon transition from a normal condition to a specific condition and if the other node is found decreasing in terms of either expression level or expression degree upon transition from the normal condition to the specific condition, then the detecting step may regard the node group as a node group including the molecular switch (e.g., by carrying out the switch pattern verifying process in FIG. 10).

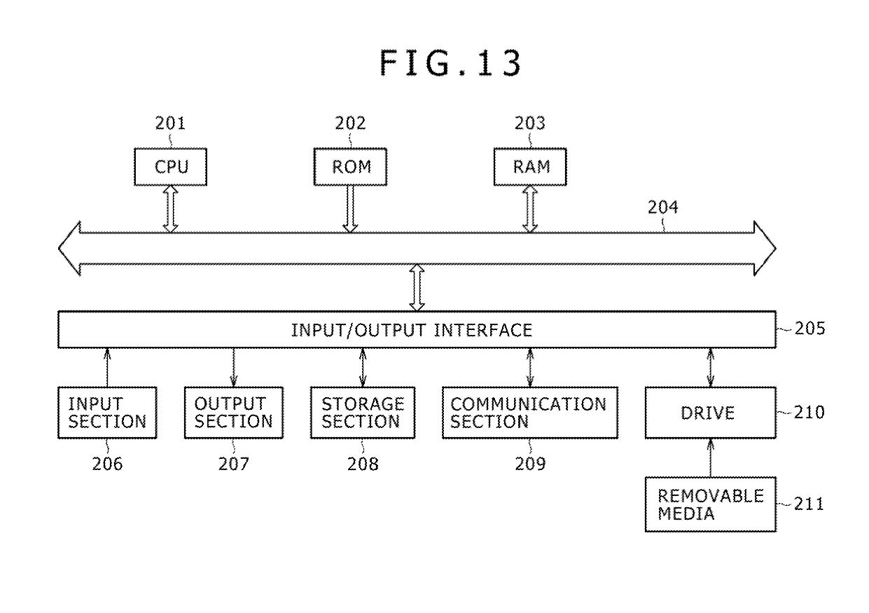

A further embodiment of the present invention is a program for causing a computer (e.g., of which the structure is shown in FIG. 13) to carry out the above-outlined information processing apparatus practiced as an embodiment of the invention.

The preferred embodiments of the present invention will now be described in reference to the accompanying drawings.

FIG. 2 is a functional block diagram showing a typical functional structure of an information processing apparatus 11 practiced as an embodiment of the present invention.

Linked with a database 12, the information processing apparatus 11 in FIG. 2 constitutes an information processing system.

The information processing apparatus 11 has the function of detecting from a given cellular network a link pattern (called a switch pattern) of a node group (molecule group) including at least two nodes (two molecules) potentially constituting a molecular switch candidate. This function will be referred to as the switch pattern detecting function in the ensuing description. The switch pattern detecting function will be discussed later in detail with reference to FIGS. 3 through 9.

The information processing apparatus 11 also has the function of verifying which of the node groups detected as switch patterns actually contains the molecular switch. This function will be referred to as the switch pattern verifying function in the ensuing description. The switch pattern verifying function will be discussed later in detail with reference to FIGS. 10 and 11. The information processing apparatus 11 of this embodiment implements the switch pattern verifying function typically as follows: from the node groups each detected as a switch pattern, the node group in which two molecules (nodes) linked directly or indirectly according to the switch pattern in question have predetermined patterns of changes in terms of expression level or expression degree under a normal condition (e.g., normal cell) and a specific condition (e.g., cancer cell) is detected as a node group containing a molecular switch.

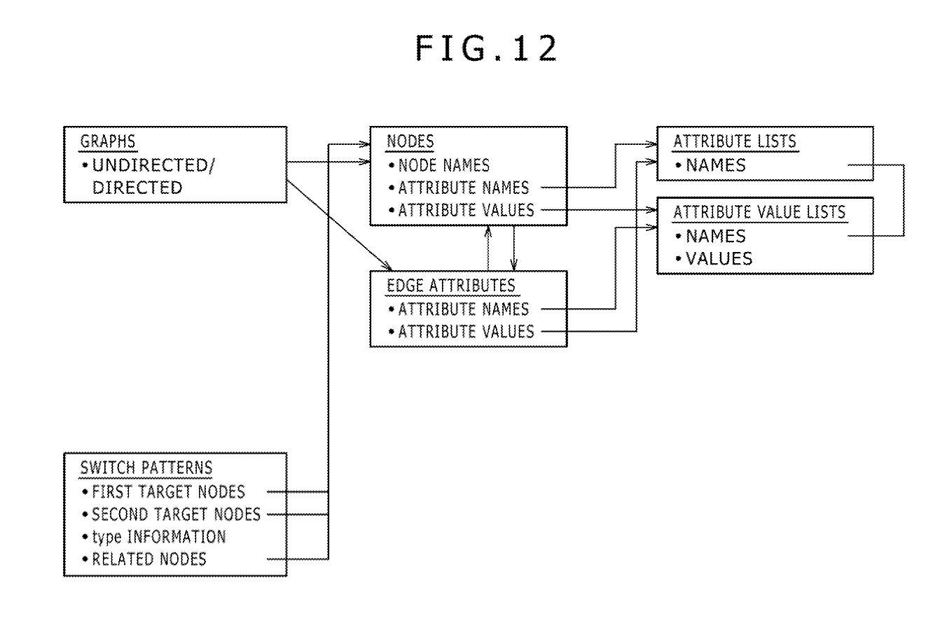

The database 12 stores diverse kinds of data necessary for implementing the switch pattern detecting function and the switch pattern verifying function. Particular examples of such data will be explained in the ensuing description with reference to FIGS. 3 through 11. A typical structure of the principal data used by the functions will be discussed later with reference to FIG. 12.

In order to implement the switch pattern detecting function and switch pattern verifying function, the information processing apparatus 11 is structured to include components ranging from a data processing section 21 to a user interface (UI) section 25,

Some of the major components of the information processing apparatus 11 will be explained below. A data reading section 23 under control of the data processing section 21 reads various data from the database 12 and supplies the retrieved data to a processing section 31, A data writing section 24 also under control of the data processing section 21 writes to the database 12 the data sent, from the processing section 31. Examples of the data written to and read from the database 12 will be described later in reference to FIG. 3 and the subsequent drawings.

A data analysis section 22 under control of the data processing section 21 analyses diverse kinds of data and provides the results of the analysis to the data processing section 21. Examples of the data to be analysed will foe explained later in reference to FIG. 3 and the subsequent drawings.

In bringing about the switch pattern detecting function and switch pattern verifying function, the data processing section 21 processes various data by suitably controlling the components ranging from the data analysis section 22 to the data writing section 24 outlined above. More specifically, the actual processing of data is effected by the processing section 31. The data submitted to the processing section 31 for processing and the data leaving the processing section 31 after the processing are accommodated by a holding section 32 as necessary. Examples of the data subject to the processing will be discussed later in reference to FIG. 3 and the subsequent drawings.

As its name implies, the user interface section 25 provides a user interface for users. The user interface section 25 functions interface device between the user and the processing section 31 in the data processing section 21. More specifically, the user interface section 25 includes an input section 41 and a display section 42, The input section 41 is used by the user to input commands and other information. The display section 42 presents various kinds of information to the user in onscreen display form. The types of information to be input through the input section 41 and examples of the information displayed by the display section 42 will be explained later in reference to FIG. 3 and the subsequent drawings.

The switch pattern detecting function and the switch pattern verifying function will now be described in more detail.

Of the processes for implementing the switch pattern detecting function or the switch pattern verifying function, those performed by the processing section 31 by controlling the data analysis section 22 and other components may alternatively be carried out by the processing section 31 alone. Conversely, the processes executed by the processing section 31 alone may alternatively be carried out by the processing section 31 controlling the data analysis section 22 and other components.

The switch pattern detecting function will be explained below in detail with reference to FIGS. 3 through 9.

For purpose of simplification and illustration, the switch pattern is defined as follows.

In advance as a positive loop which is formed by a node group (molecule group) including at least two nodes (two molecules) potentially constituting a molecular switch candidate and in which at most two paths (for linking nodes) link the two molecules (two nodes) as the molecular switch candidate.

More specifically, the switch patterns defined for this embodiment of the invention fall into three major categories: type 1 shown in FIG. 3, type 2 in FIG. 4, and type 3 in FIGS. 5 through 7.

In FIGS. 3 through 7, each shaded circle indicates one of the two nodes (two molecules) potentially constituting a molecular switch, candidate. Each hollow circle represents the other of the two nodes (the other molecule).

In the ensuing description, the nodes each indicated by a shaded circle as a node potentially constituting a molecular switch candidate in FIGS. 3 through 7 will be referred to as target nodes. Where it is necessary to distinguish two target nodes, one of them will be referred to as a first, target node and the other as a second target node. The remaining nodes each indicated by a hollow circle in FIGS. 3 through 7 will be referred to as related nodes.

In FIGS. 3 through 7, each solid line stands for a P link, and each dotted line for an N link. As seen in FIGS. 3 through 5, there are cases in which the link going from a first node to a second node is a P or an N link and the link in reverse from the second node to the first node is also a P or an N link, respectively.

Of these bidirectional links, the N link going from the first node to the second node and the N link in reverse from the second node to the first node are said to constitute an NN link.

Likewise, of these bidirectional links, the P link going from the first node to the second node and the P link in reverse from the second node to the first node are said to constitute a PP link.

The NN link and PP link are called the same-sign link each.

Type 1, as shown in FIG. 3, involves two object nodes being linked to each other in the NN link and each of the two nodes being linked with itself in the P link.

Type 2, as indicated in FIG. 4, involves two object nodes being linked to each other in the NN link and each of the two nodes being linked to the related node in the same-sign link.

More specifically, it is assumed that each object node on the left-hand side in FIG. 4 is a first object node and each object node on the right-hand side in the same drawing is a second object node. Given that assumption, type 2 may fail into one of three switch patterns “a,” “b” and “c” as shown in FIG. 4 depending on the node link patterns, i.e., on how the first and the second object nodes are each linked to the related node.

For example, under the switch pattern “a” of type 2, two object nodes are linked to each other in the NN link. According to this pattern, the first object is linked to the related node in the PP link and so is the second object node to the related node in the PP link.

Under the switch pattern “b” of type 2, two object nodes are linked to each other in the NN link. According to this pattern, the first object node is linked to the related node in the PP link whereas the second abject node is linked to the related node in the NN link.

Where the first object, node is linked to the related node in the NN link and the second object node is linked to the related node in the PP link, this type-two setup may be classified, as the switch pattern “b” of type 2 if the two object nodes are linked to each other in the NN link.

Under the switch pattern “c” of type 2, two object nodes are linked to each other in the NN link, the first object node is linked to the related node in the NN link, and the second object node is linked to the related node in the NN link.

In FIG. 5, shaded boxes each with the notation α/β in the middle indicate link patterns in which two object nodes are linked bidirectionally via a related node. That is, these link patterns each, have the two object, nodes linked both ways by two paths. Type 3 is thus any one of the switch patterns where these link patterns exist and where each of the two object nodes inside is linked to a different related node.

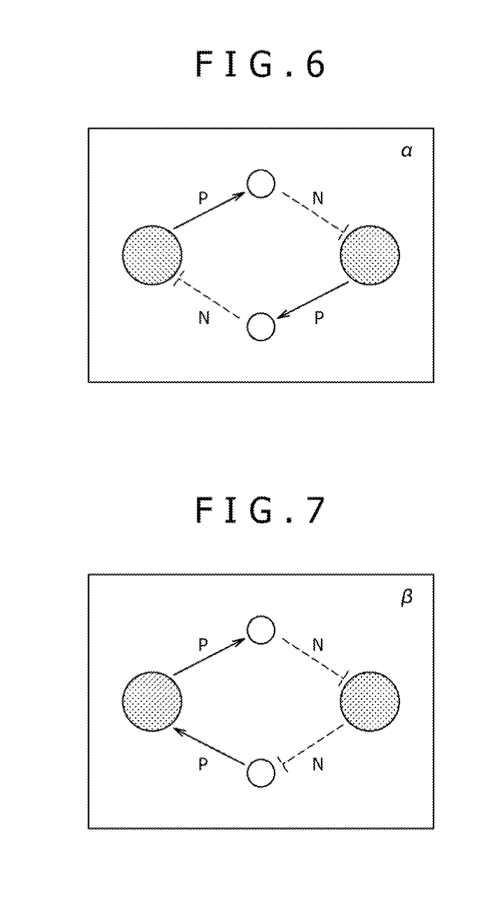

More specifically, the link pattern represented by each of the shaded boxes in FIG. 3 corresponds either to the link pattern in the box indicated by reference character a in FIG. 6, or to the link pattern in the box designated by reference character β in FIG. 7.

For FIG. 6 in which the link pattern is in the box marked with α, it is assumed that the object node on the left-hand side is referred to as a first object node and the object node on the right-hand side as a second object node. On that assumption, the first object node in FIG. 6 is linked to the related node shown on top in the P link and this related node is linked to the second object node in the N link, whereby the first object node is linked to the second object node. The second object node is further linked to the related node shown at bottom in the P link and this related node is linked to the first object node in the N link, whereby the second object node is linked to the first object node.

For FIG. 7 in which the link pattern is in the box marked with β, it is also assumed that the object node on the left-hand side is referred to as a first object node and the object node on the right-hand side as a second object node. On that assumption, the first object node in FIG. 7 is linked to the related node shown on top in the P link and this related node is linked to the second object node in the N link, whereby the first object node is linked to the second object node. The second object node is further linked to the related node shown at bottom in the N link and this related node is linked to the first object node in the P link, whereby the second object node is linked to the first object node.

If it is assumed that the left-hand side object node is the first object node and the right-hand side object node is the second object node in FIG. 6 or 7, then type 3 in FIG. 5 may fall into one of four switch patterns “a” through “d” as illustrated in the drawing depending on the node link patterns, i.e., on how the first and the second object nodes are each linked to the related node.

Illustratively, under the switch pattern “a” of type 3, the first object node in FIG. 6 or 7 is linked to the related node in the PP link and the second object node in the same drawing is linked to the related node in the PP link.

Under the switch pattern “b” of type 3, the first object node in FIG. 6 or 7 is linked to the related node in the NN link and the second object node in the same drawing is linked to the related node in the PP link.

Under the switch pattern “c” of type 3, the first object node in FIG. 6 or 7 is linked to the related node in the PP link and the second object node in the same drawing is linked to the related node in the NN link.

Under the switch pattern “d” type 3, the first, object node in FIG. 6 or 7 is linked to the related node in the NN link and the second object node in the same drawing is linked to the related node in the NN link.

To sum up, each of the switch patterns “a” through “d” of type 3 in FIG. 5 is matched with two switch patterns of the link patterns indicated by reference characters α and β in FIGS. 6 and 7, respectively. It follows that a total of eight switch patterns belong to type 3,

The above-defined switch patterns categorized into type 1 through type 3 are only examples; other suitable definitions may be adopted alternatively. Although the switch patterns are defined in advance according to this embodiment, this is not limitative of the present invention. The switch patterns may be defined in a differently timed manner. For example, as soon as the user inputs certain information, the information processing apparatus 11 may define switch patterns based on the input information.

Described below in reference to the flowchart of FIG. 8 is a typical process for detecting a molecule group (node group) corresponding to a switch pattern from a given cellular network. The process will be called the switch pattern detecting process hereunder.

In step S1, the processing section 31 in FIG. 2 controls the data reading section 23 to read link information from the database 12 and causes the holding section 32 to hold the retrieved link information.

One item of link information denotes the nature of the link between the first node and the second node (i.e., how the first node links to the second node). Illustratively, each item of link information may be formed by entries of “First node,” “Attribute representative of how the first node links to the second node,” and “Second node.”

It should be noted that the first and the second nodes can be either object nodes or related nodes. It should also be noted that the first node can double as the second node in the self-link makeup described above.

A “First node” entry may be the name of the first node (e.g., molecule name).

An entry of “Attribute representative of how the first node links to the second node” may be constituted by the attribute indicating the P link or by the attribute representing the N link. These attributes may be called edge attributes where appropriate.

A “Second node” entry may be the name of the second node (e.g., molecule name).

Each item of link information indicates that each of a plurality of molecules included in the cellular network is the first node and either doubles as the second node or is linked to another molecule. There are as many items of link information as the number of molecules of which each can link to itself. For purpose of simplification and illustration, this embodiment of the invention assumes that a plurality of items of link information were generated and placed into the database 12 in advance.

Even if such link information is not generated beforehand, the link information may be generated from the data structured as shown in FIG. 12, How the link information is generated will be explained as part of the subsequent description of what is shown in FIG. 12.

In any case, once the items of link information are placed into the holding section 32, control is passed from step S11 to step S12.

In step S12, the processing section 31 extracts a node group including at least two object nodes on the basis of the link information.

In step S13, the processing section 31 controls the data analysis section 22 to determine whether the extracted node group corresponds to one of the switch patterns (type 1 through type 3),

If the extracted node group is found corresponding to one of the switch patterns (types 1 through 3), i.e., if the node group is detected as a switch pattern (“YES” in step S13), then control is passed from step S13 to step S14.

In step S14, the processing section 31 stores into a predetermined file (called the switch file) object node information, type information, and related node information as the information indicative of the detected switch pattern. Step S14 is followed by step S15.

The switch file may be stored either in the database 12 or in the holding section 32. If the switch file is located in the database 12, then the processing section 31 controls the data writing section 24 to write the object node information, type information, and related node information to the switch file.

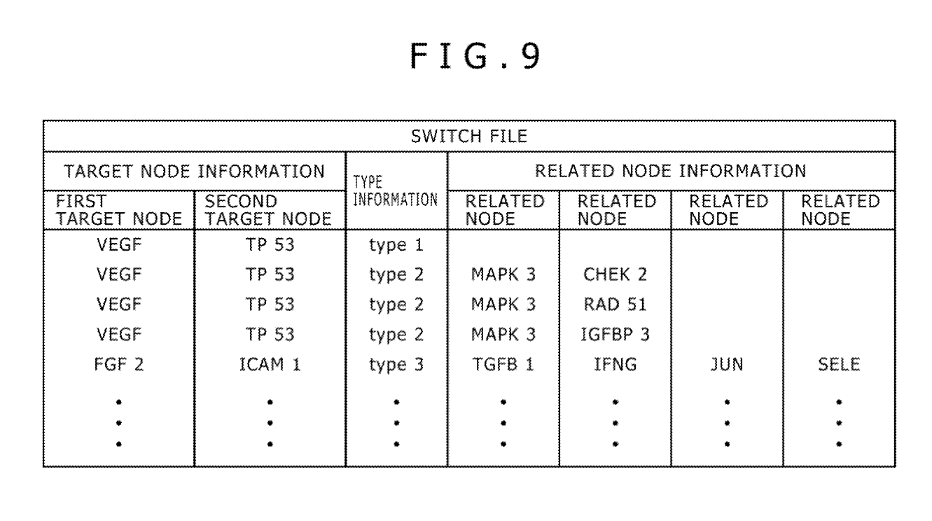

More specifically, the switch file such as one shown in FIG. 9 is stored into the database 12 or into the holding section 32.

In the switch file of FIG. 9, each row of information corresponds to one node group detected as a switch pattern.

In the switch fire, the “Object node information” column is made up of the “First object node” column and the “Second object node” column. Each row in the “First object node” column stores the name of the molecule constituting the first object node. Each row in the “Second object node” column accommodates the name of the molecule forming the second object node. Illustratively, of the link information retrieved in step S11 above, the “First node” and “Second node” names constituting the first and the second object nodes are stored into the respective columns.

In the “Type information” column, each row stores information (e.g., character string) indicating the switch pattern (one of type 1 through type 3) corresponding to the node group in question.

The “Related node information” column is formed by multiple “Related node” columns. Each row across the “Related node” columns accommodates the names of the molecules constituting the related nodes in the node group of interest. Illustratively, of the link information retrieved in step S11 above, the names of the first and the second nodes constituting the related nodes are stored into the “Related node information” column.

Returning to rig. 8, if the node group extracted in step S12 is found corresponding to one of the switch patterns (types 1 through 3), then the result of the check in step S13 is affirmative (“YES”). In this case, step S13 is followed by the processing of step S14 which in turn is followed by step S15.

If in step S13 the node group extracted in step S12 is not found to correspond with any of the switch patterns (“NO” in step S13), then the node group in question is not regarded as a switch pattern by this embodiment. In such a case, step S14 is skipped and step 315 is reached.

In step S15, the processing section 31 checks to determine whether or not another switch pattern is ready to be detected.

If it is determined in step S15 that another switch pattern is ready to be detected, then processing is returned to step S12 and the subsequent steps are repeated. That is, steps S12 through S15 are repeated in a loop. Every time a node group corresponding to a switch pattern is detected, the information about the node group constituting the switch pattern is stored into the switch file.

If it is determined in step S15 that no other switch pattern is ready to be detected, then the switch pattern detecting process is brought to an end.

This completes the detailed description of the switch pattern detecting function in reference to FIGS. 3 through 9.

Described below in detail with reference to FIGS. 10 and 11 is the switch pattern verifying function.

FIG. 10 is a flowchart of steps constituting a typical process performed by the switch pattern verifying function of the embodiment. This process will be called the switch pattern verifying process hereunder.

In step S21, the processing section 31 shown in FIG. 2 checks to determine whether the switch file (see FIG. 9) exists.

If in step S21 the switch file is not found to exist, then the processing section 31 goes to step S22, In step S22, the processing section 31 carries out the switch pattern detecting process discussed above (see FIG. 8), Step S22 is followed by step S23.

If in step S21 the switch file is found to exist, then the processing section 31 skips the switch pattern detecting process (FIG. B) of step S22 and goes to step S23.

In step S23, the processing section 31 reads the data of the switch patterns involved from the switch file. If the switch file is stored in the database 12, the processing section 31 controls the data reading section 23 to read the switch pattern data from the switch file. The data of each switch pattern is constituted by information that identifies the node group detected as the switch pattern in question. In the example of FIG. 9, each row of information (i.e., object node information, type information, and related node information) makes up the switch pattern data.

In step S24, the processing section 31 reads verification data from a predetermined, file. If that file is located in the database 12, the processing section 31 controls the data reading section 23 to read the verification data from the file in the database 12,

The verification data is data about the molecules each potentially constituting the first or the second target node. The data includes the levels and degrees of expression of the nodes under a normal condition (e.g., normal cells) and a specific condition (e.g., cancer cells).

In step S25, the processing section 31 controls the data analysis section 22 to check the data of each switch pattern against the verification data in terms of levels and degrees of expression. If one of the nodes making up a given switch pattern is found to have an increasing pattern and the other node is found with a decreasing pattern on the basis of the verification data, then the data of that switch pattern is regarded as successfully verified data.

What follows is the definition of “The data of which one target node is found to have an increasing pattern and the other target node is found with a decreasing pattern based on the expression levels and degrees of the verification data.”

The data of a given switch pattern includes the first target node (name of a molecule) and the second target node (name of another molecule). From the verification data, the processing section 31 acquires the expression level or degree of the molecule constituting the first object node under the normal condition (e.g., normal cell; the level or degree is called the value Ah in this case) and under the specific condition (e.g., cancer cell; the level or degree is called the value AN in this case). Likewise, the processing section 31 acquires from the verification data the expression level or degree of the molecule constituting the second object node under the normal condition (e.g., normal ceil; the level or degree is called the value BN in this case) and under the specific condition (e.g., cancer cell; the level or degree is called the value BA in this case). The processing section 31 proceeds to calculate ΔA=AN AA and ΔB=BN BA.

In terms of transition from normal cell to cancer cell, if ΔA is positive, then the first object node is regarded as decreasing; if ΔA is negative, then the first object node is found increasing. Likewise, if ΔB is positive, then the second object node is regarded as degreasing; if ΔB is negative, then the second object node is found increasing.

As a result, there are two kinds of “The data of which one target node is found to have an increasing pattern and the other target node is found with a decreasing pattern based on the expression levels and degrees of the verification data”: the data of the pattern switch of which ΔA is positive and ΔB is negative, and the data of the pattern switch of which ΔA is negative and ΔB is positive.

Each switch pattern identified by such data includes a set of object nodes recognized as an actual molecular switch. That data is considered the successfully verified data.

In step S26, the processing section 31 stores the successfully verified data into a predetermined file (called the switch result file hereunder). This brings the switch pattern verifying process to an end.

The switch result file may be stored either in the database 12 or in the holding section 32. If the switch result file is located in the database 12, then the processing section 31 controls the data writing section 24 to write the successfully verified data to the switch result file in the database 12.

Illustratively, the switch result file such as one shown in FIG. 11 is written to the database 12 or stored into the holding section 32.

In the switch result file of FIG. 11, each row of data corresponds to one item of successfully verified data, i.e., the data item of a node group found to include a molecular switch.

Each row in the “A” and “B” columns of the switch result file in FIG. 11 accommodates the names of the nodes (molecules) verified as molecular switches out of the node group including these nodes among others. That is, each row across the “A” and “B” columns stores data corresponding to each row of information across the “First object node” and “Second object node” columns of the switch file in FIG. 9.

Each row in the “Type” column of the switch result file holds information indicative of the switch pattern corresponding to the node group in question. That is, the “Type” column stores the information corresponding to the information in the “Type information” column of the switch file in FIG. 9.

Each row across the “Related node” columns of the switch result file stores the names of the molecules regarded as related nodes among the nodes constituting the node group in question. That is, the “Related node” columns of the switch result file store the information corresponding to the information in the “Related node” columns of the switch file in FIG. 9.

Each row across the “ΔA” and “ΔB” columns of the switch result file accommodates the results of the above-mentioned calculations ΔA=AN AA and ΔB=BN BA, respectively, regarding the node group in question.

Each row in the “Signal reverse” column of the switch result file stores “1” if the corresponding node group has successfully verified data, i.e., if the pattern switch in question is such that ΔA is positive and ΔB is negative, or ΔA is negative and ΔB is positive. Otherwise each row in the “Signal reverse” column accommodates “0.” However, because the switch result file stores only the successfully verified data according to this embodiment, the “Signal reverse” column stores only “1's.”

That is, the switch result file shows typical sets of molecules (e.g., protein tissues) detected as molecular switches from the cellular networks having been tested. When the present invention is practiced as described above, pairs of molecules (e.g., protein tissues) regarded as molecular switches can be detected easily and quickly from given cellular networks. The results of the detection (such as the above-described switch result file) may be used to help develop cures for cancers and determine their probable origins or causes.

The information processing apparatus 11 in FIG. 2 capable of attaining such results may carry out the series of processes above through the use of principal data structured as shown in FIG. 12. FIG. 12 is a schematic view showing a typical structure of principal data for use by the information processing apparatus 11. The data is described “for use by the information processing apparatus 11” because the data structure in FIG. 12 is predicated on the presence of the database 12 in FIG. 2 as well as on the holding section 32 inside the information processing apparatus 11. The data structure in FIG. 12 need not be established in the database 12 alone; it may be set up in the holding section 32 as necessary.

In FIG. 12, the data enclosed by rectangles including the underlined character strings (graphs, nodes, attribute lists, etc.) constitute what may be called character string data. The character string data, made up of graph data, node data, attribute list data, edge attribute data, attribute value list data, and switch pattern data, will be discussed individually below.

The node data is data which identifies a given node and includes a node name, an attribute name, and an attribute value. Each node can thus be identified by its node data including such data elements as the node name, attribute name, and attribute value. The node name is the data indicating the name of a given node, such as the name of a protein molecule. The attribute name is the data which indicates, among a plurality of attributes (e.g., large, medium, or small molecule) characterizing each molecule, the name of the attribute under which the node in question is categorized. The attribute value is the data indicative of the value corresponding to the attribute name.

The edge attribute data is the data indicating an edge attribute attached to a given node.

The edge attribute is defined as follows: when a first node links to a second node, the first node may exert some influence on the second node. A particular type of such influence is called the edge attribute in this specification. Specifically, there exist a first attribute and a second attribute under the edge attribute category.

The first attribute applies to the case in which the first node renders the second node functionally positive (promoted/strengthened/increased). Thus the first attribute is named “P.” That is, when the first-node links to the second node in the P link, the edge attribute is said to be P.

As opposed to the first attribute, the second attribute applies where the first node renders the second node functionally negative (inhibited/weakened/decreased). Thus the second attribute is named “N.” That is, when the first node links to the second node in the N link, the edge attribute is said to be N.

The name P and the name N are each given a unique value (attribute value). With this embodiment of the invention, the attribute value of P is “2” and that of “N” is “1.”

To sum up, the type of the link (edge attribute) going from the first node to the second node is determined by the edge attribute data about the first node. The edge attribute data is constituted by attribute name data and attribute value data.

Where the first node links to itself as described above, i.e., where the first node doubles as the second node, the edge attribute data about the first node is also created.

Where the first node and the second node are linked bidirectionally as described above, the data indicating the type of the link (edge attribute) going from the second node to the first node is created apart from the data denoting the type of the link going from the first node to the second node.

Numerous kinds of molecules (of protein) exist as nodes in a given cellular network, each of the nodes (molecules) being associated with the corresponding node data. If a given node (i.e., node identified by one node data item) is matched with a plurality of linkable other nodes (identified, by other node data items), then there can be different types of links (edge attribute) between the node in question and each of the other nodes. That means there exists edge attribute data about each of the multiple other nodes.

Suppose that with the first node linked to the second node, the P or N edge attribute is attached to the first node. In such a case, the graph data in the data structure of FIG. 12 shows which molecule becomes the first node, which molecule becomes the second node, and how the first node links to the second node (type of link, or edge attribute). In the graphic notation, different types of links (edge attribute) may be designated by directed (arrowed) lines or undirected lines. In either case, the lines to be used should be defined beforehand, and these definitions should also be stored as data in advance.

There are numerous items of node data and edge data as described above. These data items are arranged into list information composed of attribute list data and attribute value list data. The attribute list data involves listing the relations between the attribute names of the node data items on the one hand, and the attribute values of the edge attributes on the other hand. The attribute value list data involves listing the relations between the attribute values of the node data items on the one hand, and the attribute names of the edge attribute data items on the other hand.

Meanwhile, the switch pattern data corresponds to the switch file (see FIG. 9) and to the switch result file (see FIG. 11).

Diverse kinds of data are stored in the database 12 or in the holding section 32 in FIG. 12 in accordance with the data structure illustrated in FIG. 12. The examples of the diverse kinds of data have been discussed above.

The link information retrieved in step S11 of FIG. 8 was shown to be created beforehand in the example above. Alternatively, if the data structure of FIG. 12 is in place, then the link information may be created by the processing section 31 in step S11 as described below.

At the expense of repetition, it should be noted that the link information indicates the nature of linkage between the first node and the second node (i.e., the manner in which the first node links to the second node). More specifically, the link information is made up of first node data, edge attribute data (i.e., attribute indicating the type of link going form the first node to the second node in the above example), and second node data.

In the structure of FIG. 12, the first node data may be the node name as part of the node data about the first node.

Also in this structure, the edge attribute data may be the attribute name or attribute value as part of the edge attribute data about the second node linked with the first, node.

In the same example of FIG. 12, the second node data may be the node name as part of the node data about the second node.

That is, the processing section 31 may regard one of a plurality of node data items kept in the database 12 as the node data about the first node and may read the node name of the first node as the first node.

The second node linked with the first node may be identified by the graph data in the structure of FIG. 12, Based on the graph data, the processing section 31 may identify the second node and may read the node name of the node data about the second node as the second node. The processing section 31 may further read as the edge attribute the attribute name or the attribute value as part of the edge attribute data about the second node.

In the manner described above, one item of link information is read out.

Alternatively, the link information may be read not by using the node data or edge attribute data itself but by utilizing the attribute list data or attribute value list data.

The present invention has been described above using an embodiment whereby a plurality of molecule groups (node groups) corresponding to predefined switch patterns (type 1 through type 3 in the example) are detected from a cellular network at a given point in time. Of the multiples node groups, one that contains a molecular switch is detected through the use of predetermined verification data. However, this is an example and is not limitative of the present invention.

Alternatively, the present invention may be applied to cases of time series analysis.

For example, the link information about a given cellular network is input on a time series basis. A molecular switch (i.e., a molecule group containing the molecular switch) is then detected from each of the chronologically arranged items of link information. The detected molecular switches are compared with one another in terms of levels and degrees of expression for time series analysis.

The switch patterns may not be predefined as described above. They may be defined alternatively as follows

Illustratively, the user may input a value “n” (an integer of at least two) by operating the input section 41 shown in FIG. 2. In turn, the processing section 31 controls the data analysis section 22 to detect from as many as “n” nodes the node groups each constituting a positive loop based on the link information about the cellular network being tested. The patterns of the detected node groups are defined as the switch patterns by the processing section 31.

In another example, the user may input another value “n” by operating the input section 41. In turn, the processing section 31 controls the data analysis section 22 to detect node groups each constituting a positive loop through as many as “n” paths between two nodes based on the link information about the cellular network being tested. The patterns of the detected node groups are then defined as the switch patterns by the processing section 31.

In yet another example, the user interface section 25 shown in FIG. 2 may be provided with a GUI (graphical user interface) whereby the user may create graph patterns such as those shown in FIGS. 3 through 7 as desired. The processing section 31 then defines the graph patterns created through the GUI as the switch patterns.

The series of steps or processes described above may be executed either by hardware or by software.

The software-based processing may be carried out illustratively by the personal computer shown in FIG. 13 at least as part of the above-described information processing apparatus 11 in FIG. 2.

In FIG. 13, s CPU (central processing unit) 201 performs various processes according to the programs recorded in a ROM (read only memory) 202 or based on the programs loaded from a storage section 203 into a RAM (random access memory) 203. When necessary, the RAM 203 accommodates data that may be demanded by the CPU 201 in executing its processing.

The CPU 201, ROM 202, and RAM 203 are interconnected by way of a bus 204. An input/output interface 205 is also connected to the bus 204.

The input/output interface 205 is connected with an input section 206, an output section 207, a storage section 208, and a communication section 209. The input section 206 is typically made up of a keyboard and a mouse. The output section 207 is illustratively constituted by a display unit, the storage section 208 by a hard disk, and the communication section 209 by a modem and/or a terminal adapter. The communication section 209 controls communications with another apparatus (not shown) via networks such as the Internet.

The input/output interface 205 is also connected with a drive 210 as necessary. The drive 210 is loaded with removable media 211 such as a magnetic disk, an optical disk, a magneto-optical disk, or a semiconductor memory. Computer programs retrieved from the loaded removable medium may be installed into the storage section 208 where necessary.

Where the series of steps or processes above is to be carried out by software, the programs constituting the software may be either incorporated beforehand in dedicated hardware of the computer for program execution or installed upon use over a network or from a suitable recording medium into a general-purpose personal computer or like equipment capable of executing diverse functions based on the installed programs.

As shown in FIG. 13, the program recording medium is offered to users not only as removable media 211 (package media) apart from their computers and constituted by magnetic disks (including floppy disks), optical disks (including CD-ROM (compact disc-read only memory) and DVD (digital versatile disk)), magneto-optical disks (including MD (Mini-disc)), or a semiconductor memory, each of the media carrying the necessary programs; but also in the form of the ROM 202 or the hard disk in the storage section 208, each medium having been loaded with the programs prior to shipment to the users.

In this specification, the steps describing the programs stored on the program recording medium represent not only the processes that are to foe carried out in the depicted sequence (i.e., on a time series basis) but also processes that may be performed parallelly or individually and not chronologically.

In this specification, the term “system” refers to an entire configuration made up of a plurality of component devices and processing-related sections, illustratively, the information processing apparatus 11 and database 12 in FIG. 2 may be considered a single apparatus altogether.

It should be understood by those skilled in the art that various modifications, combinations, sub-combinations and alterations may occur depending on design requirements and other factor in so far as they are within the scope of the appended claims or the equivalents thereof.

What is claimed is:

1. An information processing apparatus for processing information about a network including a plurality of nodes representative of cellular molecules, said information processing apparatus comprising:
a defection section configured to detect from said network a node group corresponding to a switch pattern including at least two nodes potentially constituting a candidate of a molecular switch.

2. The information processing apparatus according to claim 1,
wherein said switch pattern is defined as a positive group in which at most two paths link the two nodes potentially constituting the candidate of said molecular switch, and
said detection section detects the node group corresponding to said switch pattern based on the definition of the pattern.

3. The information processing apparatus according to claim 1,
wherein said switch pattern is defined as one of a plurality of positive loop types, and
said detection section detects a node group corresponding to one of said plurality of positive loop types as said node group corresponding to said switch pattern.

4. The information processing apparatus according to claim 3,
wherein if a first node links to a second node in such a manner that said first nods renders said second node functionally positive, then the link is defined as a P link,
if first node links to said second nodes in such a manner that said first node renders said second node functionally negative, then the link is defined as an N link,
if said first node links to said second node in said P link or in said N link and if said second node links to said first node also in said P link or in said M link, then the link is defined as a PP link or an NN link, respectively,
said PP link and said NN link are defined as a same-sign link each,
of said node group constituting said positive loop, the two nodes potentially constituting said candidate of said molecular switch are regarded as target nodes and the other nodes as related nodes,
said plurality of positive loop types include a first, a second, and a third type,
said first type involves said two target nodes being linked to each other in said NN link and each of said two target nodes linking to itself in said P link,
said second type involves said two target nodes being linked to each other in said NN link, and each of said two target nodes being linked with said related nodes in said same-sign link, and
said third type involves said two target nodes being linked bidirectionally via one of said related nodes and each of said two target nodes being linked with the other related nodes in said same-sign link.

5. The information processing apparatus according to claim 1, wherein following the detection of at least said node group corresponding to said switch pattern including at least the two nodes potentially constituting said candidate of said molecular switch, if one of said two nodes is found increasing in terms of either expression level or expression degree upon transition from a normal condition to a specific condition and if the other node is found decreasing in terms of either expression level or expression degree upon transition from said normal condition to said specific condition, then said detection section regards said node group as a node group including said molecular switch.

6. The information processing apparatus according to claim 5,
wherein under each of said normal condition and said specific condition, there is provided verification data indicating at least either said expression level or said expression degree regarding the molecules which can be said nodes of said network, and
based on said verification data, said detection section detects the node group including said molecular switch from at least said node group corresponding to said switch pattern.

7. An information processing method for use with an information processing apparatus for processing information about a network including a plurality of nodes representative of cellular molecules, said information processing method comprising the step of:
detecting from said network a node group corresponding to a switch pattern including at least two nodes potentially constituting a candidate of a molecular switch.

8. The information processing method according to claim 7, wherein following the detection of at least said node group corresponding to said switch pattern including at least the two nodes potentially constituting said candidate of said molecular switch, if one of said two nodes is found increasing in terms of either expression level or expression degree upon transition from a normal condition to a specific condition and if the other node is found decreasing in terms of either expression level or expression degree upon transition from said normal condition to said specific condition, then said detecting step regards said node group as a node group including said molecular switch.

9. A program for causing a computer to process information about a network including a plurality of nodes representative of cellular molecules, said program comprising the step of:
detecting from said network a node group corresponding to a switch pattern including at least two nodes potentially constituting a candidate of a molecular switch.

10. The program according to claim 9, wherein following the detection of at least said node group corresponding to said switch pattern including at least the two nodes potentially constituting said candidate of said molecular switch, if one of said two nodes is found increasing in terms of either expression level or expression degree upon transition from a normal condition to a specific condition and if the other node is found decreasing in terms of either expression level or expression degree upon transition from said normal condition to said specific condition, then said detecting step regards said node group as a node group including said molecular switch.

11. An information processing apparatus for processing information about a network including a plurality of nodes representative of cellular molecules, said information processing apparatus comprising:
detection means for detecting from said network a node group corresponding to a switch pattern including at least two nodes potentially constituting a candidate of a molecular switch.
